(19) United States
(12) Patent Application Publication
(10) Pub. No.: US 2004/0137307 A1
(43) Pub. Date: Jul. 15, 2004

(54) Seal construction for fuel cell

(76) Inventors: Daisuke Okonogi, Saitama (JP); Hiroyuki Tanaka, Saitama (JP); Tadashi Nishiyama, Saitama (JP); Keisuke Andou, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/721,784

(22) Filed: Nov. 26, 2003

(30) Foreign Application Priority Data
Nov. 27, 2002 (JP) 2002-343784
Nov. 27, 2002 (JP) 2002-343785
Nov. 27, 2002 (JP) 2002-343786
Oct. 29, 2003 (JP) 2003-368809

(51) Int. Cl. H01M 2/08; H01M 8/02

(52) U.S. Cl. 429/37; 427/115; 429/36

(57) ABSTRACT

A seal-separator conjugation for a fuel cell which clamps a membrane electrode assembly sandwiching both surfaces of a polymer electrode membrane, comprising seals on a front surface and a rear surface of the separator at least at one end of the separator is disclosed. The conjugation is produced by pre-forming a rubber material or rubber materials into pre-formed seals within a mold having at least one supporting member for positioning the seal; inserting a separator between the pre-formed seals; and vulcanizing the pre-formed seals into the final seals while maintaining the pre-formed seals and the separator.

### BACKGROUND ART

1. Field of the Invention

The present invention relates to a seal construction for fuel cell. More particularly, the invention relates to a seal-separator conjugation comprising a seal unified with a seal for fuel cell and a membrane electrode assembly with a seal, and their production processes.

2. Description of Related Arts

In recent years, polymer electrolyte fuel cell (PEFC) has been attracted as a motive power for example for automobile. PEFC can generate power even at a normal temperature and, thus, it has increasingly been put into a practical application in many applications.

Generally speaking, a fuel cell system comprises an electrolyte membrane interposed between and sectioned by a cathode at one side and an anode at the other side, and is a system in which electric power is generated by an electrochemical reaction between oxygen contained in air, which is supplied to the cathode, and hydrogen, which is supplied to the anode, and an external load is driven by such a generated power.

Fuel cell stack 100 is provided in such a type of fuel cell system as shown in FIG. 13A. A plurality units of a single cells, into which one membrane is interposed and which generates power, laminated for example in a horizontal direction so that the surface of the electric pole become vertical and they are fastened for example by a bolt to configure a fuel cell stack 100.

As shown in FIG. 13, the single cell is composed of a polymer electrolyte membrane M, electrode catalyst layers C, and C, gas diffusion layers D and D, separators SA and SH and the like. It is noted that an assemble is sometimes referred to as “membrane electrode assembly”, which is composed of one electrode catalyst layer C and one gas diffusion layer D provided on one surface of the polymer electrode membrane M and the other electrode catalyst layer C and the other gas diffusion layer D provided on the other surface of the polymer electrode membrane M. Symbol RS in FIG. 13B is a rubber-made seal material.

Amongst them, the separators SA and SH are each used for tying up cells composed of lamination of a plurality of single cells in order to obtain a desired voltage and are required to have the following functions:

(1) A function that secures supply passages each for supplying hydrogen and oxygen to a cell within the fuel cell stack 100;

(2) A function that secure a supply passage for supplying a coolant for the fuel cell stack 100;

(3) A function that collects and takes out current (electrons).

These separators SA and SH are in the state of lamination when they are formed as the fuel cell (See FIG. 12), a liquid sealing property between these separators SA and SH in one single cell, which is a constitution unit, is required in order to prevent leakage of hydrogen, air and water out of the system.

Specifically, in such a type of the fuel cell, there is a possibility that when the separator is deformed due to external impact or vibration, the neighboring separators are brought into contact with each other to make a short circuit, or for example, due to the coolant used for cooling the fuel cell. water produced from the reaction between hydrogen and oxygen, or dew condensed water

Objects of the present invention is to provide a seal-separator conjugation, a seal-membrane electrode assembly conjugation and processes for producing them. Another object of the present invention is to provide a seal-membrane electrode assembly conjugation possessing seals each having properties suitable for application environments. Still another object of the present is to provide a seal-membrane electrode assembly conjugation which are difficult to be slanted, and processes for producing them in a precise manner.

### SUMMARY OF THE INVENTION

A seal-separator conjugation for a fuel cell according to the present invention clamps a membrane electrode assembly sandwiching both surfaces of a polymer electrode membrane, and comprises seals on a front surface and a rear surface of the separator at least at one end of the separator.

In the seal-separator conjugation according to the present invention, said seal preferably has a fitting construction fitted to a seal formed on a neighboring separator or a neighboring membrane electrode assembly.

Also, in the seal-separator conjugation according to the present invention, the seal formed on the front surface and the seal formed on the rear surface are preferably made of different rubber materials. In this embodiment, the seal formed on the surface of the separator at the air passage side may be made of a rubber material having oxygen resistance and the seal formed on the surface of the separator at the coolant passage side may be made of a rubber material having resistance to a coolant.

Also, the seal-separator conjugation according to the present invention may possess a seal portion for a communication pore, which coats the inside of the communication pore, and an outer circumference seal portion, which coats portions from the outer circumference of the communication pore to the outer circumference of the separator.

Furthermore, in the seal-separator conjugation according to the present invention, said separator and said seal portions are adhered by an insulating primer/adhesive.

In the seal-separator conjugation according to the present invention, said seal has at least one pore originated from the mold for forming the conjugation in a vertical direction to the direction of the front and rear surfaces of the separator. In this embodiment, said pore is sealed with an insulating material.

According to the present invention, there is provided a process for producing a seal-separator conjugation for a fuel cell having seals on a front surface and a rear surface of the separator at least at one end of the separator, which comprises:

a pre-forming stage for pre-forming a rubber material or rubber materials into pre-formed seals;

a sandwiching stage for inserting a separator between said pre-formed seals; and

a vulcanizing stage for vulcanizing the pre-formed seals into the final seals while maintaining said pre-formed seals and said separator.

In the process according to the present invention, said seal-separator conjugation possesses a seal portion for a communication pore, which coats the inside of the communication pore, and an outer circumference seal portion, which coats portions from the outer circumference of the communication pore to the outer circumference of the separator, wherein an insulating rubber composition is used to pre-from said seal portion for a communication pore and said outer circumference seal portion in said pre-forming stage; and wherein said separator and said pre-formed seals are adhered with an insulating primer-adhesive in sandwiching stage.

Also, according to the present invention a process for producing a seal-separator conjugation for a fuel cell having seals on a front surface and a rear surface of the separator at least at one end of the separator is provided, which comprises:

a pre-forming stage for pre-forming a rubber material or rubber materials into pre-formed seals within a mold having at least one supporting member for positioning said seal;

a sandwiching stage for inserting a separator between said pre-formed seals; and

a vulcanizing stage for vulcanizing the pre-formed seals into the final seals while maintaining said pre-formed seals and said separator.

Also, the present invention provide a seal-membrane electrode assembly conjugation for a fuel cell which is sandwiched by a separator and clamps a membrane electrode assembly, comprising seals on a front surface and a rear surface of the membrane electrode assembly at least at one end of the separator, and a process for producing a seal-membrane electrode assembly conjugation for a fuel cell which is sandwiched by a separator and clamps a membrane electrode assembly, comprising seals on a front surface and a rear surface of the membrane electrode assembly at least at one end of the separator, which comprises:

a pre-forming stage for pre-forming a rubber material or rubber materials into pre-formed seals;

a sandwiching stage for inserting a membrane electrode assembly between said pre-formed seals; and

a vulcanizing stage for vulcanizing the pre-formed seals into the final seals while maintaining said pre-formed seals and said membrane electrode assembly.

Also provided herein is a process for producing a seal-membrane electrode assembly conjugation for a fuel cell which is sandwiched by a separator and clamps a membrane electrode assembly, comprising seals on a front surface and a rear surface of the membrane electrode assembly at least at one end of the separator, which comprises:

a pre-forming stage for pre-forming a rubber material or rubber materials into pre-formed seals within a mold having at least one supporting member for positioning said seal;

a sandwiching stage for inserting a membrane electrode assembly between said pre-formed seals; and

a vulcanizing stage for vulcanizing the pre-formed seals into the final seals while maintaining said pre-formed seals and said membrane electrode assembly.

### BRIEF DESCRIPTION OF THE DRAWINGS

FIG. 1 is a cross-sectional view of a single cell utilizing a seal-separator conjugation according to one embodiment of the present invention.

FIG. 2 is a cross-sectional view showing laminated single cells.

FIG. 3 is a drawing for explaining the stages for producing the seal-separator conjugation, wherein

FIG. 3A shows a stage for pre-forming a rubber composition into a pre-formed seal,

FIG. 3B shows a stage for inserting a separator between the pre-formed seals,

FIG. 3C shows a stage for holding the pre-formed seals and the separator and vulcanizing the pre-formed seals, and

FIG. 3D shows a completed product.

FIG. 4 is a cross-sectional view of a single cell utilizing a seal-MEA conjugation according to one embodiment of the present invention.

FIG. 5 is a drawing for explaining the stages for producing the seal-separator conjugation according to the second embodiment, wherein

FIG. 5A shows a stage for pre-forming a rubber composition into a pre-formed seal,

FIG. 5B shows a stage for inserting a separator between the pre-formed seals,

FIG. 5C shows a stage for holding the pre-formed seals and the separator and vulcanizing the pre-formed seals, and

FIG. 5D shows a completed product.

FIG. 6A and FIG. 6B each is a plane view each showing the seal-separator conjugation according to the second embodiment,

FIG. 6C is a cross-sectional view showing the seal-separator conjugation of A-A cross-section of FIG. 6A and the seal-separator conjugation of B-B cross-section of FIG. 6B are laminated.

FIG. 7A and FIG. 7B each is a plane view each showing the seal-separator conjugation according to a specific embodiment in the second embodiment,

FIG. 7C is a cross-sectional view showing the seal-separator conjugation of A-A cross-section of FIG. 7A and the seal-separator conjugation of B-B cross-section of FIG. 7B are laminated.

FIG. 8 is a cross-sectional view of a single cell utilizing a seal-MEA conjugation according to another embodiment of the present invention.

FIG. 9 is a schematic view showing a specific embodiment of the present invention where the seal-separator conjugations are piled up.

FIG. 10 is a cross-sectional view of single cells.

FIG. 11 is a drawing for explaining the stages for producing the seal-separator conjugation, wherein

FIG. 11A shows a stage for pre-forming a rubber composition into a pre-formed seal,

FIG. 11B shows a stage for inserting a separator between the pre-formed seals,

FIG. 11C shows a stage for holding the pre-formed seals and the separator and vulcanizing the pre-formed seals, and

FIG. 11D shows a completed product.

FIG. 12 is a cross-sectional view of single cells according to the third embodiment.

FIG. 13A is a perspective view showing the outlook of the conventional fuel cell stack and

FIG. 13B shows a configuration of a single cell.

### DESCRIPTION OF PREFERRED EMBODIMENTS

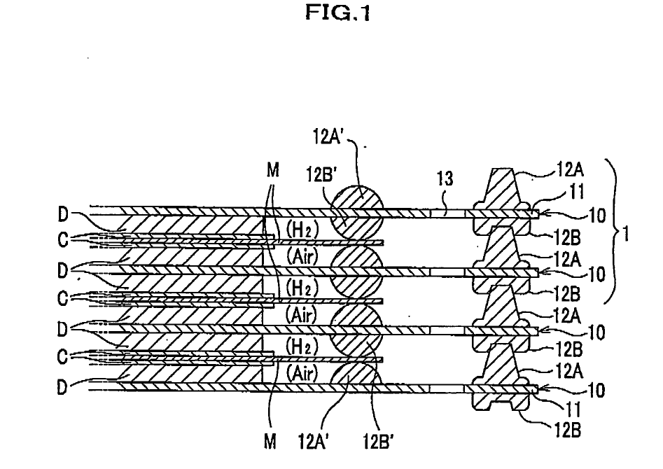

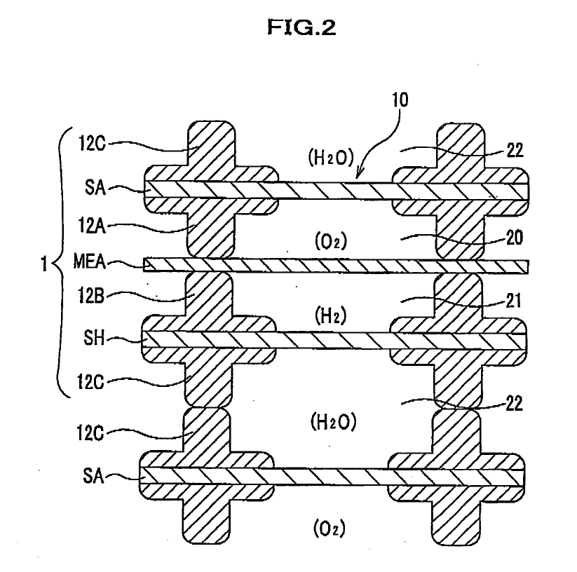

The present invention will now be described in detail by referring to the drawings. However, the present invention is not restricted to the following embodiment. FIG. 1 is a cross-sectional view of a single cell utilizing a seal-separator conjugation according to one embodiment of the present invention, and FIG. 2 is a cross-sectional view showing laminated single cells.

The term “seal-separator conjugation” used herein intended to encompasses a seal equipped with a separator. In the following description, the seal-separator conjugation is used.

<<First Embodiment>>

As shown in FIGS. 1 and 2, a single cell 1 is composed of seal-separator conjugations (fuel cell separators) 10 and 10 provided so as to sandwich a polymer membrane electrode M having electrode catalyst layers C and C, gas diffusion layers D and D.

The seal-separator conjugations 10 and 10 are each formed by unifying a plate-from separator SA (or SH) with a pair of seals 12A and 12C which are provided in front and rear surfaces of the plate-from separator SA (or SH) at both ends thereof.

The separator SA (or SH) is used for providing a function of a filling function between cells (lamination function) in a fuel cell stack in which a plurality of cells are laminated to obtain a desired voltage.

Materials for suitably used in producing the separators SA and SH include, but are not restricted to, steel plates, stainless steel plates, aluminum plates, plated steel plates, metal plates having been surface treated fro corrosion proofing, and carbon-containing material comprising a mixture of synthetic graphite or graphite with resins. The thickness of the separators SA and SH is not also restricted. In a specific embodiment, the thickness is from 0.05 to 0.3 mm.

The seal 12A is formed on a surface of the separator SA facing to an air passage 20, which is formed between the separator 12A and the membrane electrode assembly MEA, and the seal 12 C is formed on a surface of the separator SA facing to a coolant passage 22. The seal 12B is formed on a surface of the separator SH facing to a hydrogen passage 21, and the seal 12C is formed on a surface of the separator SA facing to a coolant passage 22.

These seals 12A, 12B and 12C are each formed so that a part of the seal is in a convex form at the end of the surface formed on the separator SA or SH. For example, taking the surface of the separator 11 as a standard, the thickness of the seal which coats the separator is approximately 0.05 to 0.4 mm, and the height of the convex portion is approximately 1 mm.

These seals 12A, 12B and 12C are made of a rubber composition.

The rubber material used herein is a composition for forming a sealing material by a vulcanization and may comprises a rubber ingredient, a vulcanizing agent and a vulcanizing accelerator as main ingredients and an optional additives, which are known in the art.

Examples of the rubber ingredients (rubber materials) which can be used herein include, but are not restricted to, various synthetic rubbers such as nitrile rubbers, silicone rubbers, fluorinated rubbers, acrylic rubbers, styrene-butadiene rubbers, ethylene-propylene rubbers, tetrafluorinated ethylene rubbers, acrylonitrole-butadiene rubbers, isoprene rubbers, butadiene rubbers, butyl rubbers, chrloropyrene rubbers, ethylene-propylene-diene rubber (EPDM) rubbers, urethane rubbers, chlorosulfonated rubbers, chlorinated rubbers, as epichlorohydrin rubbers, natural rubbers (NBR), and blends thereof.

Amongst these rubber ingredients, one or a combination of two or more ingredients can be selected depending upon properties required for a seal to be formed.

Specifically, for the seal 12A, natural rubbers, isoprene rubbers, butadiene rubbers, styrene rubbers, butyl rubbers, ethylene-propylene rubbers, chlororpyrene rubbers, hyparon, nitrile rubbers, acrylic rubbers, urethane rubbers, polysulfide rubbers, silicone rubbers, fluorinated rubbers, chlorosulfonated polyethylene rubbers, epichlorohydrin rubbers and the like can suitably be utilized as a rubber ingredient having oxygen resistance.

For the seal 12B, natural rubbers, isoprene rubbers, butadiene rubbers, styrene rubbers, butyl rubbers, ethylene-propylene rubbers, chloropyrene rubbers, hyparon, acrylic rubbers, urethane rubbers, fluorinated rubbers, and the like can suitably be utilized as a rubber ingredient having hydrogen resistance.

When it is desired for a seal to have an electrical insulating property, natural rubbers, isoprene rubbers, styrene-butadiene rubbers, butyl rubbers, butadiene rubbers, ethylene-propylene rubbers, hyparon, polysulfide rubbers, silicone rubbers, chlorosulfonated polyethylene rubbers, fluorinated rubbers and the like can suitably ne selected.

In the rubber composition used herein, kinds and amounts of the vulcanizing agent and vulcanizing accelerator are suitably selected from the compounds and their amounts known per se. For example, the vulcanizing agents include sulfur, peroxides, polyamines, thiuran-disulfide etc, and vulcanizing accelerators include guanidines, thioureas, thiazoles, dithiocarbamines and the like.

As other ingredient colorants such as titanium dioxide, red iron oxide, and ultramarine may be utilized, for example, for coloring the seals 12A, 12B, 12C for classification.

The composition composed of the ingredients described above becomes a viscose fluid as a rule when it is heated.

(Production)

Next, a production of seal-separator conjugation of the present invention will now be described.

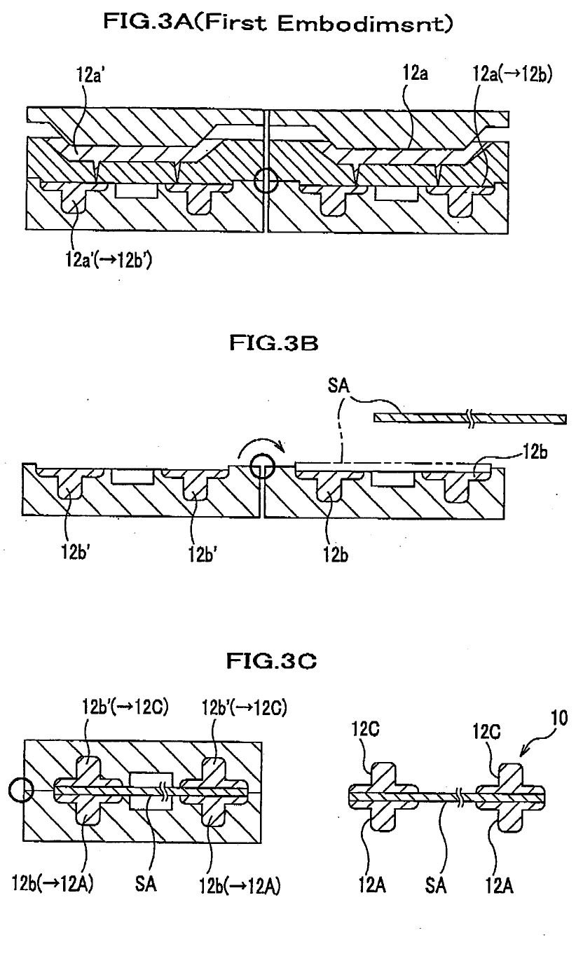

FIG. 3 is a drawing for explaining the stages for producing the seal-separator conjugation, wherein FIG. 3A shows a stage for pre-forming a rubber composition into a pre-formed seal, FIG. 3B shows a stage for inserting a separator between the pre-formed seals, FIG. 3C shows a stage for holding the pre-formed seals and the separator and vulcanizing the pre-formed seals, and FIG. 3D shows a completed product.

The term “pre-formed seal” intended herein is a sealing material from which a seal having desired properties is produced by the vulcanization. The term “pre-forming” intended herein is the operation that the rubber composition is processed into a state capable of holding a prescribed shape and capable of further hardening. In other words, the term “pre-forming” means semi-hardens the rubber composition.

First, as a first stage, rubber compositions 12a, and 12a′ are pre-formed (pre-forming stage: see FIG. 3A). The rubber composition 12a finally becomes the seal 12A and the rubber composition 12b finally becomes the seal 12C.

The pre-forming stage is a stage for forming pre-formed seals 12b and 12b′ each having a prescribed shape, and is not a stage for completely vulcanizing the rubber composition to form the finished seals 12A and 12C.

The pre-formed seals 12b and 12b′ are formed on the front surface and the back surface of the separator 12A, respectively, and the pre-formed seal formed on the front surface and that on the rear surface are separately formed.

Depending upon the ingredients in the selected rubber compositions 12a and 12a′, the rubber compositions 12a and 12a′ are formed into the pre-formed seals 12b and 12b′ under the conditions where the rubber compositions 12a and 12a′ are formed into predetermined shapes respectively, by a method known per se, for example, by transfer-molding.

For example, when the rubber composition selected for the rubber composition 12a is ethylene-propylene-diene rubber (EPDM), and when it is pre-formed by transfer-molding, the pre-form conditions are from 60 to 170° C. for a period of approximately 2 minutes. As described above, the rubber composition 12a becomes the pre-formed seal 12b having a predetermined shape.

The second stage is a stage for inserting the separator SA into pre-formed seals 12b and 12b′ (sandwiching stage: See FIG. 3B).

In the sandwiching stage, the separator SA is placed on the pre-formed seal 12b for a front surface (or rear surface) pre-formed in the pre-forming stage, and the pre-formed seal 12b′ for a rear surface (or front surface) is set so as to coat the separator SA from the upside.

For the purpose preventing the seals from being formed on the separator at a position out of place in the next stage, an adhesive known in per se may be applied to either or both of the pre-formed seals 12b and 12b′ and the separator SA.

The third stage is a stage for forming vulcanizing the pre-formed seals 12b and 12b′ to form the seals 12A and 12C each having desired elasticity (vulcanization stage: see FIG. 3C).

In the vulcanization stage, the pre-formed seals 12b and 12b′ are vulcanized while holding the pre-formed seals 12b and 12B′ and the separator SA within the vulcanization mold.

For example, when the rubber composition 12a is ethylene-propylene-diene rubber (EPDM) as described previously, and when it is vulcanized by transfer-molding, the pre-formed seals between which the separator SA is inserted are vulcanized under a pressure (for example, 7.8-14.7 MPa) at 150 to 180° C. until the vulcanization is completed. By the vulcanization as described above, the seals 12A and 12C each having desired properties can be formed on the separator SA.

As the fourth stage, which is an optional, the seal-separator conjugation obtained in the vulcanization stage, which is the molded article (see FIG. 3D), may be secondarily vulcanized (secondary vulcanization stage).

The secondary vulcanization stage is an optional stage, which is not necessarily required.

In the case of carrying out the secondary vulcanization stage, the vulcanization stage is carried out before the pre-formed seals become the seals 12A and 12C each having desired properties and in a degree that seals are formed on the front and rear surfaces of the separator SA (i.e., vulcanized in a degree between the pre-formed seals 12b and 12b′ and the seals 12A and 12C). Subsequently, in the secondary vulcanization stage, the seals 12A and 12C having the final shapes are formed on the front and rear surfaces of the separator SA (For example, in the embodiment shown in FIG. 3D, the vulcanization is carried out in an oven at a temperature of from approximately 150 to 180° C. until the vulcanization is finished).

As for the separator SH, the seals can be unified in the same manner.

As described above, the following advantages can be obtained in this embodiment:

Since the seals 12A, 12B, and 12C each made of a rubber material suitable for each environment, i.e., having a resistance to oxygen, hydrogen or coolant are formed on the front and rear surfaces of the separators SA and SH, the durability of the seal-separator conjugation can be enhanced as a whole.

By classifying the seals 12A, 12B, and 12C by colors, the alignment at the time of assembly can easily be done.

Also, since a seal having partially different characteristics can be formed on a desired place, various characteristics can be provided such as compression load characteristic, insulating property, and environmental resistance.

Further according to the embodiment of the production, since the separator SA can be inserted between the pre-formed seals 12b and 12b′ each having a required shape to unify them with each other, the seals 12A and 12C (or 12B) can effectively be produced in a precision manner from the rubber compositions 12a and 12a′ without largely deforming the separator SA.

Also, when the secondary vulcanization is carried out, the period of the time for carrying out the pre-forming stage can be shortened and, thus, the vulcanization mold can effectively used in terms of the period, leading to the advantage that seal-separator conjugations can be produced on a large scale.

Also, when the secondary vulcanization is carried out, the vulcanization can be performed in a complete manner, making it possible to volatilize impurities.

According to the process of this embodiment, since a rubber composition 12a or such can be formed into a complicated shape, which has been difficult to be formed in the prior art, the seal 12A or such may be formed into a shape suitable for playing a role in cushioning material, sealing material or such.

The first embodiment of the present invention has been described. However, it should be noted that the present invention is not restricted thereto and various alternations and modifications can be made. For example, whereas the seals 12A and 12C (or seals 12B and 12C) are configured to be formed at both ends of the separator SA (or SH), the seal may only be formed at one end thereof.

Further, whereas in the seal-separator conjugation according to the first embodiment, the seals each composed of a different rubber material are applied on the front surface and the back surface of the separator, the same seal may be applied thereto.

Also, whereas the seal 12A or such is unified with the separator SA via a process including the pre-forming stage in this embodiment, the present invention is not restricted thereto. For example, seals each having been formed with different rubber materials may be adhered to the front and rear surfaces of the separator to meet the application environment. Alternatively, seals produced by an injection method, a compression method, a transfer method or such may be unified with the front and rear surfaces of the separator. Furthermore, on any one surface of the front and rear surfaces a seal may be unified with the separator, and a seal made of a rubber material different from the former may be adhered on the remaining surface thereof.

In addition, the present invention may be applied to any seal-metal plate conjugation such as an electronic part. It is needless to say that the shape, thickness of the seal or separator or any other parameter may suitably changed.

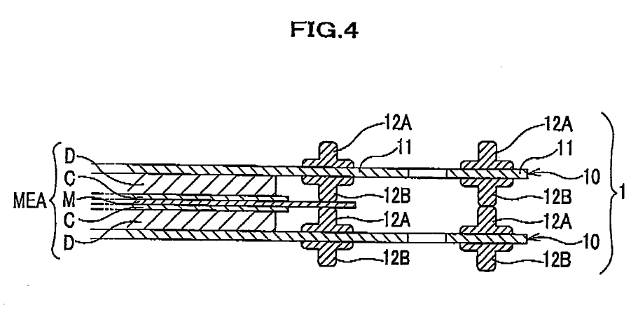

In the spirits of the seal-separator conjugation of this embodiment, seals and the membrane electrode assembly MEA may be conjugated to form a seal-MEA conjugate in a unified manner as shown in FIG. 4.

Consequently, the first embodiment may extend to a seal-MEA conjugation comprising seals and membrane electrode assembly.

Referring to FIG. 4, the seal-MEA conjugation which is a variation of the first embodiment will be described. In this embodiment, the same parts as the first embodiment are assigned to the same symbols, and the description thereof will be omitted.

A single cell 1 is composed a membrane electrode assembly MEA comprising electrode catalyst layers C, and C, gas diffusion layers D and D at both ends of a polymer electrolyte membrane M having seal-separator conjugations 10 and 10 provided on both surface thereof.

The seal-separator conjugation comprises plat-from a separator SA or SH, a pair of seals 12A and 12B which are provided in front and rear surfaces of the separator, seals 12C, 12D (or 12G and 12H) provided on the portions facing to the polymer electrolyte membrane M unified with each other.

As described above, the seals can be formed on the polymer electrolyte membrane M in a unified manner in a process similar to that of the first embodiment.

<<Second Embodiment>>

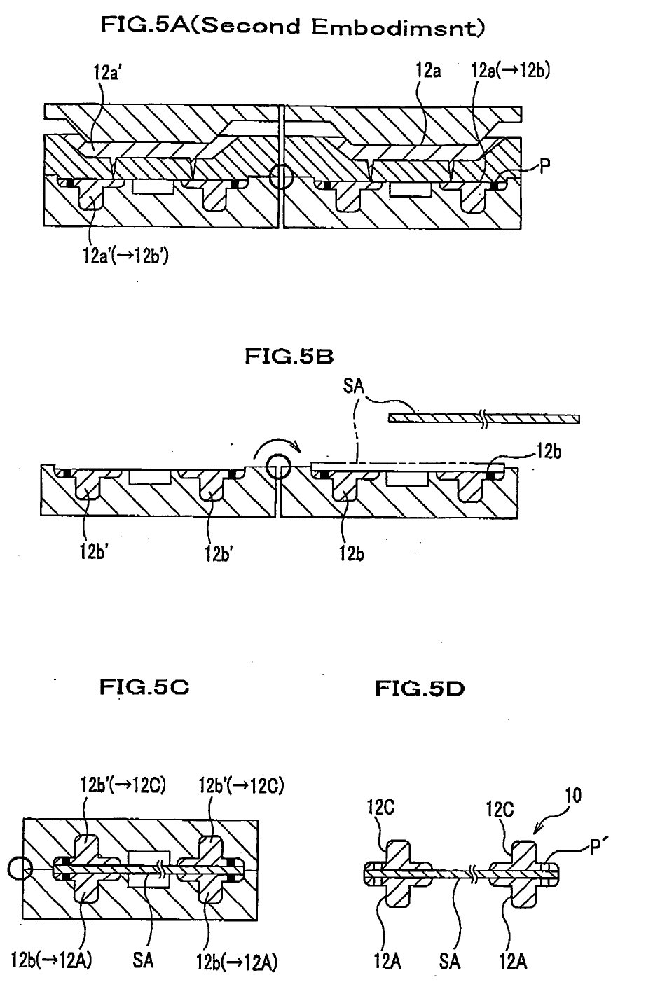

Next, the second embodiment of the present invention will be described by referring to FIG. 5 to FIG. 7.

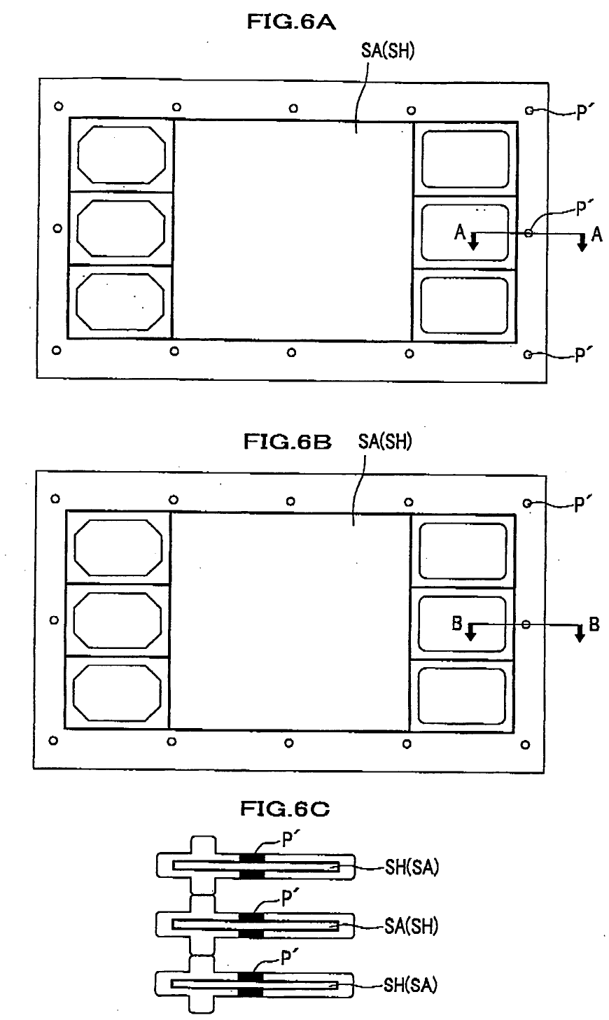

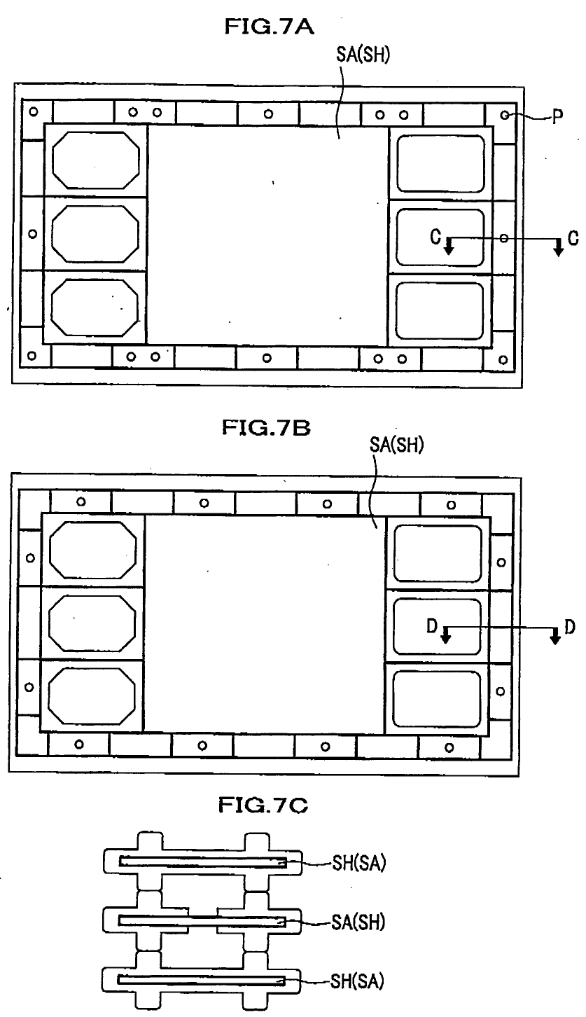

FIG. 5 is a drawing for explaining the stages for producing the seal-separator conjugation according to the second embodiment, wherein FIG. 5A shows a stage for pre-forming a rubber composition into a pre-formed seal, FIG. 5B shows a stage for inserting a separator between the pre-formed seals, FIG. 5C shows a stage for holding the pre-formed seals and the separator and vulcanizing the pre-formed seals, and FIG. 5D shows a completed product. FIG. 6A and FIG. 6B each is a plane view each showing the seal-separator conjugation according to the second embodiment, FIG. 6C is a cross-sectional view showing the seal-separator conjugation of A-A cross-section of FIG. 6A and the seal-separator conjugation of B-B cross-section of FIG. 6B are laminated. FIG. 7A and FIG. 7B each is a plane view each showing the seal-separator conjugation according to a specific embodiment in the second embodiment, FIG. 7C is a cross-sectional view showing the seal-separator conjugation of A-A cross-section of FIG. 7A and the seal-separator conjugation of B-B cross-section of FIG. 7B are laminated.

The seal-separator conjugation according to the second embodiment has the same configurations as those of the first embodiment except for the production stages and the shapes of the resulting seals 12A and 12C (or 12B and 12C).

These differences are due to the mold used for the production of the seal-separator conjugation (consequently, the production process). Specifically, in the seal-separator conjugation in this embodiment, the seal 12 has traces P′ of pins as shown in FIG. 5D.

A shown in FIG. 5A to FIG. 5C, the mold for forming the product in a unified manner has a plurality of pins P as supporting members at mutually corresponding positions in this embodiment.

The reason why the pins are provided is the alignment of the seal to be formed at the time of the unification to much more enhance the precision of the insulating coating by the seal.

The pins which can be used as the supporting members are not restricted as long as they can attain such objects as just mentioned and they do not damage the separator at the time of the unification. For example, metal-made pins having a diameter ranging from 0.2 to 1.5 mm can be utilized. The height of the pin P is preferably a height that the pin is strongly contact with the separator 11 at the time of the application of pressure in the unification process. The positions of the pins P may be the positions where the rubber composition 12 making up the seal is priced to reach the surface of the separator 11 as shown in FIG. 5A to FIG. 5C, or may be positions (end positions) where no separator exists. As described later on, when the pins P are placed at the positions where the rubber composition 12 making up the seal is priced to reach the surface of the separator 11, the pin holes may not be sealed with an insulating material depending upon the lamination process. On the other hand, when the pin holes pierce through the rubber material 12, the pin holes must be sealed with an insulating material. Consequently, the former position is preferable.

Utilizing the mold as described above, the rubber compositions 12a, 12a′ are first pre-formed in a first stage as shown in FIG. 5A, the separator SA is inserted between the pre-formed seals 12a′ and 12b′ in a second stage as shown in FIG. 5B, and then the pre-formed rubber compositions 12a and 12a′ are vulcanized as in the first embodiment in a third stage as shown in FIG. 5C.

In this embodiment, at the time of shifting the stage from the second stage to the third stage, i.e., when the mold is combined as shown by the arrow in FIG. 5B to move the pre-formed rubber composition 12, and at the time of the vulcanization stage, the rubber composition 12 is fixed by the pins P serving as the supporting members not so as to move the rubber composition 12.

For this reason, the seal-separator conjugation can be precisely produced.

The seal-separator conjugation produced as described above has seals each possessing holes P′ originated from the pins P.

Next, referring to FIG. 6 and FIG. 7, a process for laminating (piling up) the seal-separator conjugation produced in the method shown in FIG. 5 will now be described.

In the embodiment shown in FIG. 6, when the seal-separator conjugations having seals with pins P′ originated from the pins P according to the second embodiment are laminated, a first separator shown in FIG. 6A, for example, the separator SA at an air side and a second separator shown in FIG. 6B, for example, the separator SH at an hydrogen side are mutually laminated. The situation of laminating these separators are as shown in FIG. 6C.

In this case, it is required that an insulating treatment of the pins P′ with an insulating material such as silicone resin to secure the insulating property at the metal portions.

On the other hand, as shown in FIG. 7A and FIG. 7B, when there is no pore on at least one of the seals 12, only one separator exists in the separators whose metal portion is exposed within the section portion. If no pore exist in the seals of both separators SA at the oxygen side and SH at the hydrogen side, no separator whose metal portion is exposed within the section portion exists.

In this case, differing from the case shown in FIG. 6, it is not required to that an insulating treatment of the pins P′ with an insulating material such as silicone resin to secure the insulating property at the metal portions.

While the embodiment of the present invention has been described, the present invention is not restricted thereto. For example, while in the embodiment of the seal-separator conjugation, seals having different properties are provided on the front and rear surface utilizing positioning pins, the present invention is not restricted thereto, and seals having the same rubber composition may be applied to the front and rear surface.

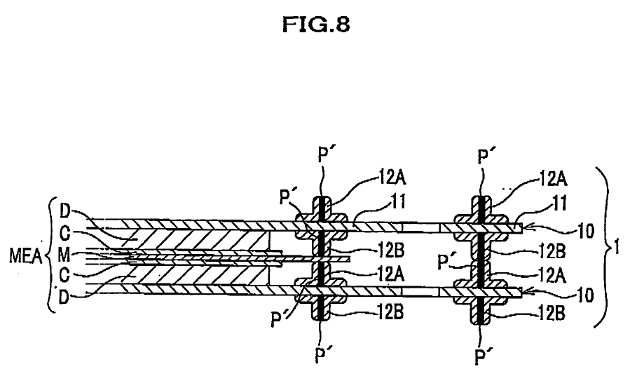

Also, instead of the seal-separator conjugation, the membrane electrode assembly MEA can be unified with seals 12 as shown in FIG. 8, the detail of which is omitted, because of similar to the description in FIG. 4.

Also, in the second embodiment, the pore is sealed with an insulating material in the second embodiment, for example, it is within the scope of the present invention that a pin composed of an insulating filling material may be inserted into the pore portions of both separators. Also, the supporting member may be devised, for example, pins, which can perform vertical piston movement, are utilized as the supporting members, they are used as the supporting members at the pre-forming stage, and no pore is provided on the seal or no pore is pierced through the seal at the vulcanization stage.

(Variation)

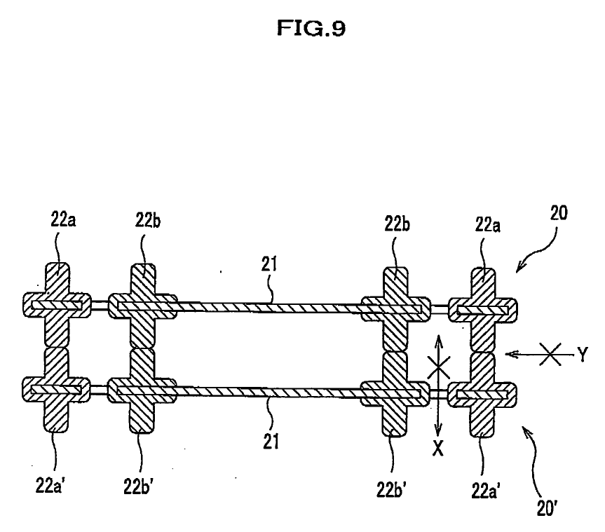

Next variation the first and second embodiments will be described by referring to FIG. 9.

FIG. 9 is a schematic view showing a specific embodiment of the present invention where the seal-separator conjugations are piled up.

As shown in FIG. 9A, the seal-separator conjugation 20 of this embodiment has outer circumference seal portions 22a and 22a made of an insulating rubber material and seals 22b and 22b for a communication pore made of an insulating rubber material on both end thereof. Each outer circumference seal 22a is an insulating rubber-made seal formed from a communication pore 23 to the edge of the separator. Each seal 22b for a communication pore is an insulating rubber-made seal, which coats the inside of the communication pore.

The thicknesses of these seal portions are not restricted as long as they exhibits their purposes and are preferably from 0.05 to 0.4 mm in terms of forming property and assembling the fuel cell stack.

By such a configuration, the insulating seal portions (22a and 22b) are formed on both ends of the communication pore of the separator 21, making it possible to prevent from liquid shortage within the fuel cell due to the produced water, dew condensed water or such as shown by the arrow X in FIG. 9.

Also, as shown in FIG. 9, when placing the seal-separator conjugations 20 and 20′ piled up with each other, the outer circumference seal portion 22a (lower side) of the seal-separator conjugation 20 is in closely contact with the outer circumference seal portion 22a′ (upper side) of the seal-separator conjugation 20′. Consequently, the earth shortage due to the coolant, external water, dew condensed water or such as shown by the arrow Y in FIG. 9 can be prevented.

By adhering the separator 21 to seal portions with an insulating primer/adhesive, even if the rubber coating is defected, or even if defect occurs due to seal fatigue, an insulating property can be kept by the insulating primer/adhesive.

As described above, the seal-separator conjugation 20 shown in FIG. 9 can be produced via the production stages shown in FIG. 3.

Specifically, by selecting a highly insulating material as the rubber composition, carrying out the pre-forming stage utilizing a vulcanization mold for forming the seal portion for a communication pore and for the outer circumference seal portion, and applying the insulating primer/adhesive to the separator, sealing portions or both in the subsequent sandwich stage, the seal-separator conjugation 20 shown in FIG. 20 can be similarly produced.

<Third Embodiment>>

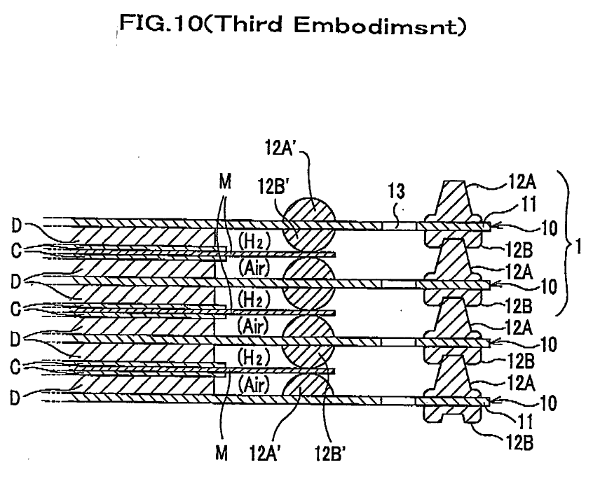

Next, the second embodiment of the present invention will be described by referring to FIG. 10. FIG. 10 is a cross-sectional view of single cells. The same parts as those of the first embodiment are assigned to the same symbols or number and the description thereof will be omitted.

The seal-separator conjugation of the third embodiment has the same configurations as those of the first embodiment except for the configuration of seals.

A single cell 1 has the same configuration as that of the first embodiment. Also, the material making up the separators SA, SH may be the same as that of the first embodiment.

As shown in FIG. 10, in this embodiment, a seal 112A is formed on both ends of a separator SA (SH) at one surface thereof in a shape where a part of the seal 112A is formed into a convex shape. A seal 112B is formed on both ends of the separator SA (SH) at the other surface thereof in a shape, a part of which is formed in a shape where a part of the seal 112B is formed into a concave shape so as to be fitted to the seal 112A. Since the shape of the end portion is symmetric, the depiction of one ends on FIG. 10 will be omitted.

Seals 112A′ and 112B′ formed on the side nearer electrodes C and C than the seals 112A and 112B facing to a communication pore 113 has a convex shape at both surface facing to the separators SA and SH so that oxygen and hydrogen are never mixed.

In this embodiment, these seals 112A, 112B, 112A′ and 112B′ are made of rubber material similar to those of the first embodiment.

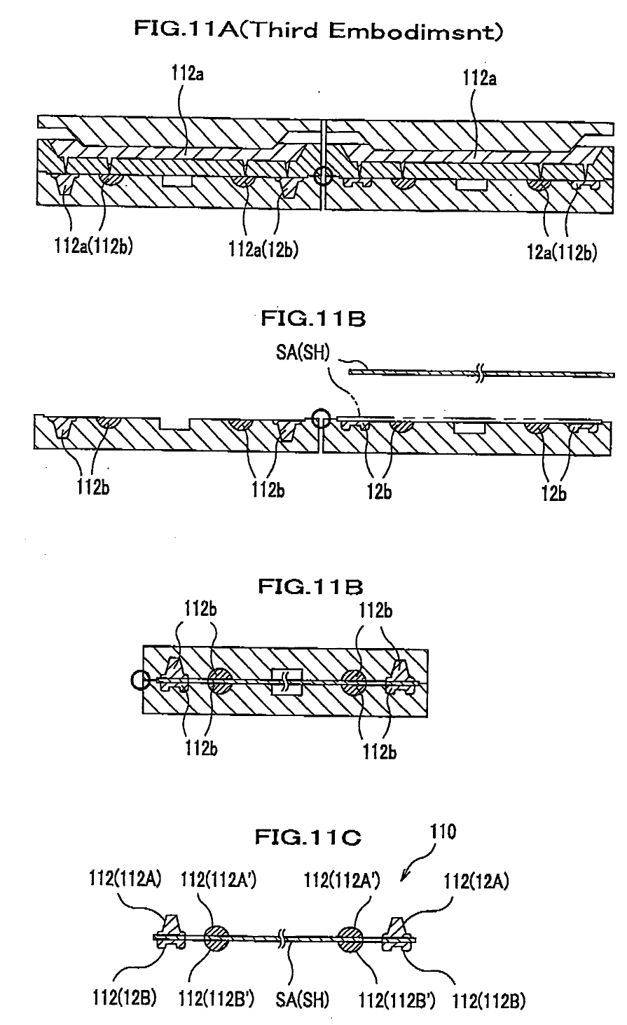

The separators SA and SH and the seals 112A, 112B, 112A′ and 112B′ (hereinafter totally referred to as seals 112) are unified to the seal-separator conjugation 110 as in the same manner as that in the first embodiment. In this production stage, the mold shown in FIG. 11 is used for producing the seal-separator conjugation according to the second embodiment. FIG. 11 is a drawing for explaining the stages for producing the seal-separator conjugation, wherein FIG. 11A shows a stage for pre-forming a rubber composition into a pre-formed seal, FIG. 11B shows a stage for inserting a separator between the pre-formed seals, FIG. 11C shows a stage for holding the pre-formed seals and the separator and vulcanizing the pre-formed seals, and FIG. 11D shows a completed product.

As shown FIG. 11, the mold for producing the seal-separator conjugation 110 has portions corresponding to the formation of convex portions and concave portion of the seal.

Utilizing the mold, the seal-separator conjugation according to the second embodiment shown in FIG. 11D can be produced through a stage for pre-forming a rubber composition into a pre-formed seal (pre-forming stage; FIG. 11A), a stage for inserting a separator between the pre-formed seals shown (sandwiching stage: FIG. 11B), a stage for holding the pre-formed seals and the separator and vulcanizing the pre-formed seals (vulcanization stage; FIG. 11C), and optional secondary vulcanization stage. These production stages can be carried out under the same condition as those in the first embodiment.

As described above, the following advantages can be obtained in this embodiment:

Since the seals 112 each formed on the neighboring separators SA and SH are formed so that they can be fitted to each other, they are difficult to be slanted even if external impact is applied, and, thus, sealing property can be enhanced.

By such a fitting configuration, contact area can be largely secured, making it possible to suppress the decreasing of sealing property, which causes the slanting of the seal.

Also the fitting configuration makes it easy to align the seal-separator configurations at the time of assembling.

The third embodiment of the present invention has been described. However, it should be noted that the present invention is not restricted thereto and various alternations and modifications can be made. For example, whereas the seals 112 are configured to be formed at both ends of the separator SA (or SH), the seal may only be formed at one end thereof.

Also, whereas the seal 112 or such is unified with the separator SA (SH) via a process including the pre-forming stage in this embodiment, the present invention is not restricted thereto. For example, seals each having been formed with different rubber materials may be adhered to the front and rear surfaces of the separator to meet the application environment. Alternatively, seals produced by an injection method, a compression method, a transfer method or such may be unified with the front and rear surfaces of the separator. Furthermore, on any one surface of the front and rear surfaces a seal may be unified with the separator, and a seal made of a rubber material different from the former may be adhered on the remaining surface thereof.

Further, similar to the first embodiment, different seals each made of materials suitable for application environments can be formed on the front and rear surface of the separator, respectively.

In addition, the present invention may be applied to any seal-metal plate conjugation such as an electronic part. It is needless to say that the shape, thickness of the seal or separator or any other parameter may suitably changed. Also, similar to the second embodiment, the mold used for forming the seal-separator conjugation according to the third embedment may possess supporting members.

<<Forth Embodiment>>

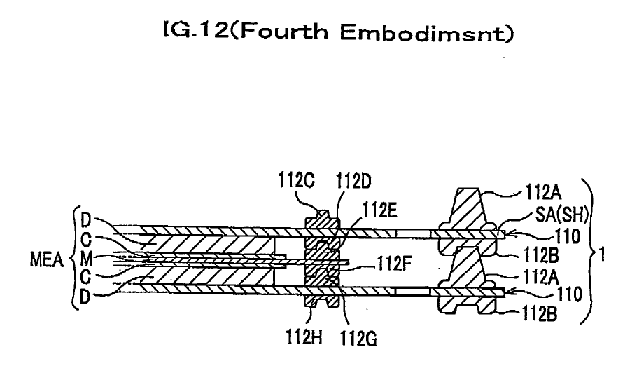

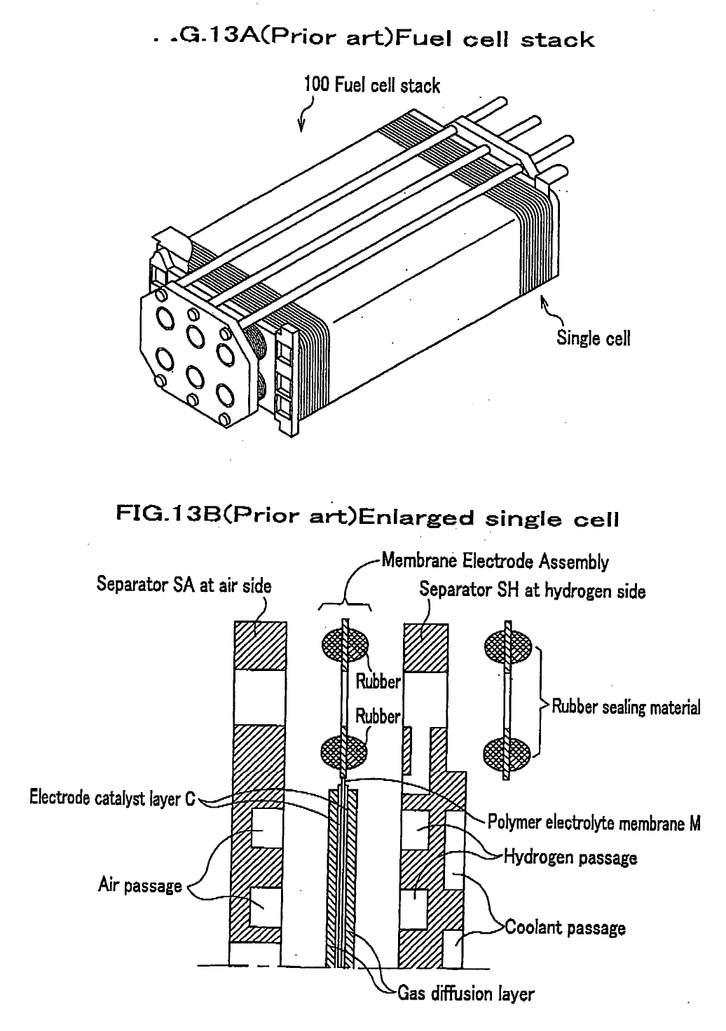

Next, the third embodiment of the present invention will be described by referring to FIG. 12. FIG. 12 is a cross-sectional view of single cells according to the third embodiment. The same parts as those of the second embodiment are assigned to the same symbols or number and the description thereof will be omitted, because this embodiment is a variation embodiment of the third embodiment.

A single cell 1 is composed a membrane electrode assembly MEA comprising electrode catalyst layers C, and C, gas diffusion layers D and D at both ends of a polymer electrolyte membrane M having seal-separator conjugations 110 and 110 provided on both surface thereof.

The seal-separator conjugation comprises plat-from a separator SA or SH, a pair of seals 112A and 112B which are provided in front and rear surfaces of the separator, seals 112C, 112D (or 112G and 112H) provided on the portions facing to the polymer electrolyte membrane M unified with each other.

In this embodiment, seals 112E and 112F are formed on a rear surface and a back surface of the polymer electrolyte membrane M exposed from the electrode catalyst layers C, and C, and the gas diffusion layers D and D in a unified manner.

The seal 112E has a shape where it is fitted to the seal 112D formed on the neighboring separator SH (or SA), and the seal 112F also has a shape where it is fitted to the seal 112G formed on the neighboring separator SH (or SA).

The seals can be formed on the polymer electrolyte membrane M in a unified manner in a process similar to that of the first to the third embodiments.

As described above, the fourth embodiment of the present invention has the following advantages.

The seals 112E and 112 F formed on the polymer electrolyte membrane M of the membrane electrode assembly MEA are formed so that they can be fitted to the seals 112D and 112G formed on the neighboring separator SH (or SA) in this embodiment. Accordingly, they are difficult to be slanted even if external impact is applied, and, thus, sealing property can be enhanced.

Also the fitting configuration makes it easy to align the seal-separator configurations at the time of assembling.

What is claimed is:

1. A seal-separator conjugation for a fuel cell which clamps a membrane electrode assembly sandwiching both surfaces of a polymer electrode membrane, comprising seals on a front surface and a rear surface of the separator at least at one end of the separator.

2. The seal-separator conjugation according to claim 1, wherein said seal has a fitting construction fitted to a seal formed on a neighboring separator or a neighboring membrane electrode assembly.

3. The seal-separator conjugation according to claim 1, wherein the seal formed on the front surface and the seal formed on the rear surface are made of different rubber materials.

4. The seal-separator conjugation according to claim 3, wherein the seal formed on the surface of the separator at the air passage side is made of a rubber material having oxygen resistance and the seal formed on the surface of the separator at the coolant passage side is made of a rubber material having resistance to a coolant.

5. The seal-separator conjugation according to claim 1, which possesses a seal portion for a communication pore, which coats the inside of the communication pore, and an outer circumference seal portion, which coats portions from the outer circumference of the communication pore to the outer circumference of the separator.

6. The seal-separator conjugation according to claim 5, wherein said separator and said seal portions are adhered by an insulating primer/adhesive.

7. The seal-separator conjugation according to any one of claims 1 to 6, wherein said seal has at least one pore originated from the mold for forming the conjugation in a vertical direction to the direction of the front and rear surfaces of the separator.

8. The seal-separator conjugation according to claim 7, wherein said pore is sealed with an insulating material.

9. A process for producing a seal-separator conjugation for a fuel cell having seals on a front surface and a rear surface of the separator at least at one end of the separator, which comprises:
a pre-forming stage for pre-forming a rubber material or rubber materials into pre-formed seals;
a sandwiching stage for inserting a separator between said pre-formed seals; and
a vulcanizing stage for vulcanizing the pre-formed seals into the final seals while maintaining said pre-formed seals and said separator.

10. The process according to claim 9, wherein said seal-separator conjugation possesses a seal portion for a communication pore, which coats the inside of the communication pore, and an outer circumference seal portion, which coats portions from the outer circumference of the communication pore to the outer circumference of the separator, wherein an insulating rubber composition is used to pre-from said seal portion for a communication pore and said outer circumference seal portion in said pre-forming stage; and wherein said separator and said pre-formed seals are adhered with an insulating primer-adhesive in sandwiching stage.

11. A process for producing a seal-separator conjugation for a fuel cell having seals on a front surface and a rear surface of the separator at least at one end of the separator, which comprises:
a pre-forming stage for pre-forming a rubber material or rubber materials into pre-formed seals within a mold having at least one supporting member for positioning said seal;
a sandwiching stage for inserting a separator between said pre-formed seals; and
a vulcanizing stage for vulcanizing the pre-formed seals into the final seals while maintaining said pre-formed seals and said separator.

12. A seal-membrane electrode assembly conjugation for a fuel cell which is sandwiched by a separator and clamps a membrane electrode assembly, comprising seals on a front surface and a rear surface of the membrane electrode assembly at least at one end of the separator.

13. The seal-membrane electrode assembly conjugation according to claim 12, wherein said seal has a fitting construction fitted to a seal formed on a neighboring separator.

14. The seal-membrane electrode assembly conjugation according to claim 12, wherein the seal formed on the front surface and the seal formed on the rear surface are made of different rubber materials.

15. The seal-membrane electrode assembly conjugation according to claim 14, wherein the seal formed on the surface of the membrane electrode assembly at the air passage side is made of a rubber material having oxygen resistance and the seal formed on the surface of the membrane electrode assembly at the coolant passage side is made of a rubber material having resistance to a coolant.

16. The seal-membrane electrode assembly conjugation according any one of claims 12 to 15, wherein said seal has at least one pore originated from the mold for forming the conjugation in a vertical direction to the direction of the front and rear surfaces of the separator.

17. A process for producing a seal-membrane electrode assembly conjugation for a fuel cell which is sandwiched by a separator and clamps a membrane electrode assembly, comprising seals on a front surface and a rear surface of the membrane electrode assembly at least at one end of the separator, which comprises:
a pre-forming stage for pre-forming a rubber material or rubber materials into pre-formed seals;
a sandwiching stage for inserting a membrane electrode assembly between said pre-formed seals; and
a vulcanizing stage for vulcanizing the pre-formed seals into the final seals while maintaining said pre-formed seals and said membrane electrode assembly.

18. A process for producing a seal-membrane electrode assembly conjugation for a fuel cell which is sandwiched by a separator and clamps a membrane electrode assembly, comprising seals on a front surface and a rear surface of the membrane electrode assembly at least at one end of the separator, which comprises:
a pre-forming stage for pre-forming a rubber material or rubber materials into pre-formed seals within a mold having at least one supporting member for positioning said seal;
a sandwiching stage for inserting a membrane electrode assembly between said pre-formed seals; and
a vulcanizing stage for vulcanizing the pre-formed seals into the final seals while maintaining said pre-formed seals and said membrane electrode assembly.
